(19) United States
(12) Patent Application Publication
(10) Pub. No.: US 2026/0185844 A1
(43) Pub. Date: Jul. 2, 2026

(54) ELECTRONIC APPARATUS LOCATED IN VEHICLE AND CONTROLLING METHOD THEREOF

(71) Applicant: SAMSUNG ELECTRONICS CO., LTD., Suwon-si (KR)

(72) Inventors: Eunjin LEE, Suwon-si (KR); Jiyoung Jeong, Suwon-si (KR); Junghyun Bang, Suwon-si (KR); Jooyoun Kim, Suwon-si (KR); Yoonyoung Kim, Suwon-si (KR); Youngsun Kim, Suwon-si (KR); Nayoung Koh, Suwon-si (KR)

(73) Assignee: SAMSUNG ELECTRONICS CO., LTD., Suwon-si (KR)

(21) Appl. No.: 19/441,280

(22) Filed: Jan. 6, 2026

Related U.S. Application Data
(63) Continuation of application No. PCT/KR2025/020893, filed on Dec. 5, 2025.

(30) Foreign Application Priority Data
Jan. 2, 2025 (KR) 10-2025-0000358

(51) Int. Cl. G01C 21/36; G06V 20/56; G06V 20/59; G06V 40/20; H04N 21/414; H04N 21/442; H04N 21/45; H04N 21/482; H04N 21/8549

(52) U.S. Cl. CPC G01C 21/3682; G06V 20/56; G06V 20/59; G06V 40/28; H04N 21/41422; H04N 21/44218; H04N 21/4524; H04N 21/4826; H04N 21/8549

(57) ABSTRACT

An electronic apparatus provided in a vehicle is provided. The electronic apparatus includes: a display; memory storing at least one instruction; and a processor. The at least one instruction, when executed by the processor individually or collectively, is configured to control the electronic apparatus to: based on detecting a user is in a seat of the vehicle, obtain information about the user and destination information; provide content obtained based on information about the seat, information about the user and the destination information; and based on a user interaction or context information for content recommendation being obtained while the vehicle is traveling, provide information about recommended content identified based on the user interaction or the context information.

### CROSS-REFERENCE TO RELATED APPLICATIONS

This application is a continuation of International Application No. PCT/KR2025/020893 designating the United States, filed on Dec. 5, 2025, in the Korean Intellectual Property Receiving Office, which is based on and claims priority to Korean Patent Application No. 10-2025-0000358, filed on Jan. 2, 2025, in the Korean Intellectual Property Office, the disclosures of which are incorporated by reference herein in their entireties.

### BACKGROUND

### 1. Field

The disclosure relates to an electronic apparatus provided in a vehicle and a controlling method thereof, and more particularly, to an electronic apparatus for providing recommended content based on context information and user interaction and a controlling method thereof.

### 2. Description of Related Art

Recently, various electronic apparatuses have been implemented in vehicles. For example, display devices disposed in seats, such as the driver's seat and the rear seat, are being provided inside vehicles. Drivers and passengers can receive various content through at least one display apparatus in the vehicle.

In related methods, multiple electronic apparatuses disposed in the vehicle may be used to recommend or provide the same content regardless of the user environment or seat type. In this regard, usability is limited due to the inability to provide different content to different electronic apparatuses.

The above information is presented as background information only to assist with an understanding of the present disclosure. No determination has been made, and no assertion is made, as to whether any of the above might be applicable as prior art with regard to the present disclosure.

### SUMMARY

In accordance with an aspect of the disclosure, an electronic apparatus provided in a vehicle, includes: a display; memory storing at least one instruction; and a processor. The at least one instruction, when executed by the processor individually or collectively, is configured to control the electronic apparatus to: based on detecting a user is in a seat of the vehicle, obtain information about the user and destination information; provide content obtained based on information about the seat, information about the user and the destination information; and based on a user interaction or context information for content recommendation being obtained while the vehicle is traveling, provide information about recommended content identified based on the user interaction or the context information.

Based on the content being navigation content, the at least one instruction, when executed by the processor individually or collectively, may be further configured to control the electronic apparatus to: based on a preset user interaction associated with the content recommendation being input at a first location on a map while the navigation content is being provided, obtain information related to the first location on the map; and provide information about an attraction or restaurant within a threshold distance of the first location based on the information related to the first location.

The electronic apparatus may further include a sensor. The at least one instruction, when executed by the processor individually or collectively, may be further configured to control the electronic apparatus to: based on detection of a user interaction in which the user points to a building outside the vehicle through the sensor while the vehicle is traveling, control a camera to obtain an image of the building; obtain information related to the building by recognizing the building through the image; and provide the information related to the building that is obtained based on the information related to the building.

The at least one instruction, when executed by the processor individually or collectively, may be further configured to control the electronic apparatus to: obtain information about an estimated time to a destination associated with the destination information while the vehicle is traveling, and compare the estimated time and remaining playback time of the content; based on the estimated time being shorter than the remaining playback time, generate summarized content by summarizing the content to correspond to the estimated time through a neural network model for summarizing content; and provide the summarized content as the recommended content.

The at least one instruction, when executed by the processor individually or collectively, may be further configured to control the electronic apparatus to: obtain information about an estimated time to a destination associated with the destination information while the vehicle is traveling, and compare the estimated time and remaining playback time of the content; and based on the estimated time being shorter than the remaining playback time, obtain and provide information about a recommended route corresponding to the remaining playback time of the content.

The at least one instruction, when executed by the processor individually or collectively, may be further configured to control the electronic apparatus to: based on identifying a communication dead zone on a route on which the vehicle is traveling, download recommended content based on a size of the communication dead zone before entering the communication dead zone; and provide the recommended content that has been downloaded while the vehicle is in the communication dead zone.

The at least one instruction, when executed by the processor individually or collectively, may be further configured to control the electronic apparatus to: obtain conversation information about a conversation of the user while the vehicle is traveling; obtain information about a new destination identified based on the conversation information; and provide content identified based on the information about the new destination.

The at least one instruction, when executed by the processor individually or collectively, may be further configured to control the electronic apparatus to: based on a preset user interaction being detected while the content is being played, obtain information about a content screen being played at a time associated with detection of the preset user interaction; obtain information about a stopover based on the information about the content screen; and based on detecting a user interaction for adding the stopover, add the stopover to a travel route.

The at least one instruction, when executed by the processor individually or collectively, may be further configured to control the electronic apparatus to: based on detection of an event in which a user terminal logged in with a user account associated with the electronic apparatus tapping the electronic apparatus, obtain information about the user and a content list from the user terminal.

The at least one instruction, when executed by the processor individually or collectively, may be further configured to control the electronic apparatus to transmit information related to the recommended content to a server managing a user account of the electronic apparatus. The server may be configured to: obtain related content based on the information related to the recommended content; and provide the recommended content or information about the related content to another electronic apparatus logged in with the user account of the electronic apparatus.

In accordance with an aspect of the disclosure, a method of controlling an electronic apparatus provided in a vehicle, includes: based on detecting a user is in a seat of the vehicle, obtaining information about the user and destination information; providing content obtained based on information about the seat, information about the user and the destination information; and based on a user interaction or context information for content recommendation being obtained while the vehicle is traveling, providing information about recommended content identified based on the user interaction or the context information.

Based on the content being navigation content, the providing information about the recommended content may include: based on a preset user interaction associated with the content recommendation being input at a first location on a map while the navigation content is being provided, obtaining information related to the first location on the map; and providing information about an attraction or restaurant within a threshold distance of the first location based on the information related to the first location.

The providing information about the recommended content may include: based on detection of a user interaction in which the user points to a building outside the vehicle through a sensor while the vehicle is traveling, controlling a camera to obtain an image of the building; obtaining information related to the building by recognizing the building through the image; and providing the information related to the building that is obtained based on the information related to the building.

The providing information about the recommended content may include: obtaining information about an estimated time to a destination associated with the destination information while the vehicle is traveling, and comparing the estimated time and remaining playback time of the content; based on the estimated time being shorter than the remaining playback time, generating summarized content by summarizing the content to correspond to the estimated time through a neural network model for summarizing content; and providing the summarized content as the recommended content.

The providing information about the recommended content may include: obtaining information about an estimated time to a destination associated with the destination information while the vehicle is traveling, and comparing the estimated time and remaining playback time of the content; and based on the estimated time being shorter than the remaining playback time, obtaining and providing information about a recommended route corresponding to the remaining playback time of the content.

In accordance with an aspect of the disclosure, a non-transitory computer readable recording medium having embodied thereon a program, which when executed by a processor of an electronic device, causes the electronic to execute a method including: based on detecting a user is in a seat of a vehicle, obtaining information about the user and destination information; providing content obtained based on information about the seat, information about the user and the destination information; and based on a user interaction or context information for content recommendation being obtained while the vehicle is traveling, providing information about recommended content identified based on the user interaction or the context information.

Based on the content being navigation content, the providing information about the recommended content may include: based on a preset user interaction associated with the content recommendation being input at a first location on a map while the navigation content is being provided, obtaining information related to the first location on the map; and providing information about an attraction or restaurant within a threshold distance of the first location based on the information related to the first location.

The providing information about the recommended content may include: based on detection of a user interaction in which the user points to a building outside the vehicle through a sensor while the vehicle is traveling, controlling a camera to obtain an image of the building; obtaining information related to the building by recognizing the building through the image; and providing the information related to the building that is obtained based on the information related to the building.

The providing information about the recommended content may include: obtaining information about an estimated time to a destination associated with the destination information while the vehicle is traveling, and comparing the estimated time and remaining playback time of the content; based on the estimated time being shorter than the remaining playback time, generating summarized content by summarizing the content to correspond to the estimated time through a neural network model for summarizing content; and providing the summarized content as the recommended content.

The providing information about the recommended content may include: obtaining information about an estimated time to a destination associated with the destination information while the vehicle is traveling, and comparing the estimated time and remaining playback time of the content; and based on the estimated time being shorter than the remaining playback time, obtaining and providing information about a recommended route corresponding to the remaining playback time of the content.

### BRIEF DESCRIPTION OF THE DRAWINGS

The above and other aspects, and advantages of certain embodiments of the disclosure will be more apparent from the following description taken in conjunction with the accompanying drawings, in which:

FIG. 1 is a block diagram illustrating configuration of an electronic apparatus according to an embodiment;

FIG. 2 is a block diagram illustrating configuration for providing recommended content included in an electronic apparatus according to an embodiment;

FIG. 3 is a flowchart provided to explain a method for providing recommended content included in an electronic apparatus according to an embodiment;

FIGS. 4A and 4B are views provided to explain a method of learning various referring expressions to recognize a user according to an embodiment;

FIGS. 5A and 5B are views provided to explain a type of content provided based on a type of seat according to an embodiment;

FIG. 6 is a view provided to explain a method of providing recommended content according to a user's lifestyle pattern according to an embodiment;

FIGS. 7A, 7B and 8 are views provided to explain a method of providing content based on a destination according to an embodiment;

FIGS. 9A and 9B are views provided to explain a method of providing recommended content based on user interaction according to an embodiment;

FIGS. 10A and 10B are views provided to explain a method of providing recommended content based on content playback time and estimated time to destination according to an embodiment;

FIGS. 11A, 11B and 11C are views provided to explain an example in which recommend content when entering an area with weak network conditions according to an embodiment;

FIG. 12 is a view illustrating a system managed under the same user account according to an embodiment;

FIG. 13 is a sequence view provided to explain an example in which an electronic apparatus provides recommended content obtained through a user terminal before boarding according to an embodiment;

FIG. 14 is a sequence diagram provided to explain an example in which content related to recommended content is provided through another electronic apparatus after disembarking according to an embodiment;

FIG. 15 is a view provided to explain an example in which a travel plan is recommended based on content being viewed according to an embodiment; and

FIG. 16 is a view provided to explain an example in which a smart home service is provided in conjunction with an electronic apparatus according to an embodiment.

### DETAILED DESCRIPTION

Various embodiments in this disclosure and the terms used herein do not intend to limit the technical features in this disclosure to specific embodiments, but should be understood to include various modifications, equivalents or alternatives.

With respect to the description of the drawings, similar components may be denoted by similar reference numerals.

The singular form of a noun corresponding to an item may include one item or a plurality of items, unless the relevant context clearly indicates otherwise.

In this disclosure, “A or B”, “at least one of A and B”, “at least one of A or B”, “A, B or C”, “at least one of A, B and C”, and “at least one of A, B, or C” may each include any one of the items listed together in the corresponding phrase, or any possible combination thereof. For example, the term “A or B”, “at least one of A and B”, or “at least one of A or B” may refer to all of the case (1) where at least one A is included, the case (2) where at least one B is included, or the case (3) where both of at least one A and at least one B are included.

As used herein, the terms “1st” or “first”, and “second”, or “2nd” may use corresponding components regardless of importance or order and are used to distinguish a component from another without limiting the components.

When it is mentioned that one (e.g., first) component is “coupled” or “connected” to another (e.g., second) component, with or without the terms “functionally” or “communicatively”, it indicates that the component can be connected to another component directly (e.g., wired), wirelessly, or through a third component.

Terms such as “have” or “include” are intended to designate the presence of features, numbers, steps, operations, components, parts, or a combination thereof described in this disclosure, but are not intended to exclude the presence or addition of one or more other features, numbers, steps, operations, components, parts, or a combination thereof in advance.

When a component is said to be “connected,” “coupled,” “supported,” or “in contact” with another component, this includes not only when the components are directly connected, coupled, supported, or in contact, but also when they are indirectly connected, coupled, supported, or in contact through a third component.

When a component is said to be located “on” another component, this includes not only a case where a component is in contact with another component, but also a case where another component exists between the two components.

The term “and/or” includes a combination of a plurality of related elements described herein or any element of a plurality of related elements described herein.

In some cases, an expression “˜an apparatus configured to” may indicate that an apparatus “is capable of” together with other apparatuses or components. For example, a “processor configured (or set) to perform A, B, and C” may indicate a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In embodiments, a ‘module’ or a ‘unit’ may perform at least one function or operation, and be implemented as hardware or hardware which operates according to software instructions. In addition, a plurality of ‘modules’ or a plurality of ‘units’ may be integrated into at least one module and be implemented as at least one processor except for a ‘module’ or a ‘unit’ that needs to be implemented as specific hardware.

Various elements and regions in the drawings are schematically drawn in the drawings. Therefore, the technical concept of the disclosure is not limited by a relative size or spacing drawn in the accompanying drawings.

Hereinafter, embodiments will be described in detail with reference to the accompanying drawings.

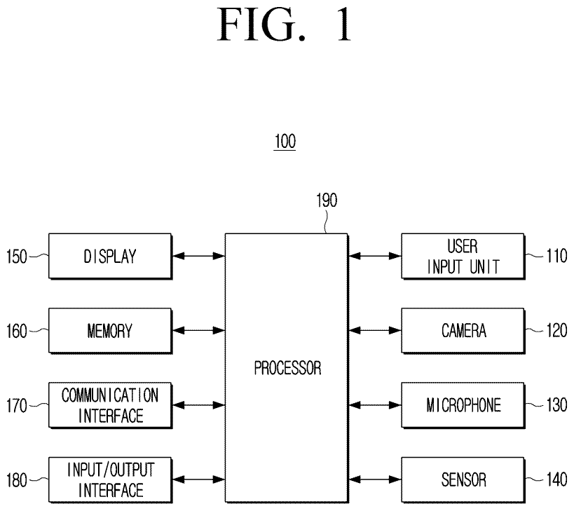

FIG. 1 is a block diagram illustrating configuration of an electronic apparatus according to an embodiment. An electronic apparatus 100 according to various embodiments may include, as shown in FIG. 1, a user input unit (e.g., user input interface) 110, a camera 120, a microphone 130, a sensor 140, a display 150, memory 160, a communication interface 170, and a processor 190. However, this is provided as an example, and depending on the type of the electronic apparatus 100, some components may be omitted or added. In particular, the electronic apparatus 100 according to an embodiment may be an in-vehicle information providing apparatus or a navigation apparatus, but embodiments are not limited thereto, and the electronic apparatus 100 may also be implemented as various devices such as a tablet personal computer (PC) or a smartphone.

The user input unit 110 is configured to receive a user input for controlling the electronic apparatus 100, and may include a button, a lever, a switch, a touch-type interface, and the like. In this case, the touch-type interface may be implemented in a manner of receiving an input through a user's touch on the screen of the display 150. The user input unit 110 may include various input devices such as a button or a remote control signal receiver.

In one or more embodiments, the user input unit 110 may detect user interaction of touching one or more points on the display 150.

The camera 120 may capture still images and moving images. The camera 120 according to various embodiments may include one or more lenses, an image sensor, an image signal processor, and a flash. The one or more lenses may include a telephoto lens, a wide-angle lens, and a super wide-angle lens disposed on a surface of the electronic apparatus 100, and may also include a three-dimensional depth lens. The camera 120 may be disposed on the surface (e.g., front side) of the electronic apparatus 100, but embodiments are not limited thereto, and the camera 120 may be an external camera provided outside the electronic apparatus 100.

In one or more embodiments, the camera 120 may capture user interactions including a pointing gesture directed forward.

The microphone 130 may detect sound and convert the sound into an electrical signal. For example, the microphone 130 may detect a voice in real time and convert the detected voice into an electrical signal, and the electronic apparatus 100 may perform an operation corresponding to the electrical signal. The microphone 130 may include a Text-to-Speech (TTS) module or a Speech-to-Text (STT) module. The microphone 130 may be included as a component of the electronic apparatus 100, or as part of an input device.

The sensor 140 may detect the state of the electronic apparatus 100 (e.g., movement) or an external environmental state (e.g., user state), and generate an electrical signal or a data value corresponding to the detected state. The sensor 140 may include, for example, a gesture sensor, an acceleration sensor, and the like.

The sensor 140 may also include a Time of Flight (ToF) sensor such as an infrared sensor or an ultrasonic sensor, to obtain information about the distance to an object (e.g., a user's hand).

The display 150 may include various types of display panels such as liquid crystal display (LCD) panel, organic light emitting diode (OLED) panel, active-matrix organic light-emitting diode (AM-OLED) panel, liquid crystal on silicon (LCoS) panel, quantum dot light-emitting diode (QLED) panel, digital light processing (DLP) panel, plasma display panel (PDP), inorganic light-emitting diode (LED) panel, and micro light-emitting diode (micro LED) panel, but embodiments are not limited thereto. The display 150 may form a touchscreen together with a touch panel, and may be implemented as a flexible panel.

According to an embodiment, the display 150 may provide recommended content obtained based on user interaction and/or context information.

According to an embodiment, the display 150 may display various user interfaces (UIs) for providing or managing recommended content.

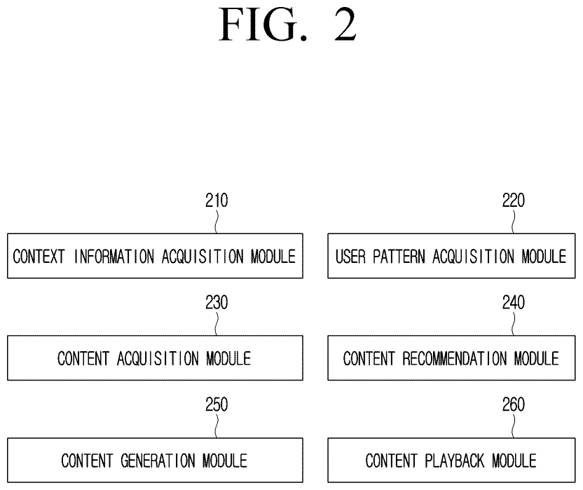

The memory 160 may store an operating system (OS) for controlling the overall operations of components of the electronic apparatus 100 and instructions or data related to components of the electronic apparatus 100. In particular, the memory 160 may include a plurality of modules (e.g., a plurality of modules as illustrated in FIG. 2) for providing recommended content. In particular, when a function for providing recommended content is executed, the electronic apparatus 100 may load, into volatile memory, data required to perform operations by the various modules stored in non-volatile memory. Here, “loading” refers to an operation in which data stored in non-volatile memory is loaded into volatile memory so that it can be accessed by the processor 190.

The memory 160 may be implemented as non-volatile memory (e.g., hard disk, Solid State Drive (SSD), flash memory) or volatile memory (e.g., memory within the processor 190).

The communication interface 170 includes at least one circuit and may perform communication with various types of external devices or servers. The communication interface 170 may include at least one of a Bluetooth Low Energy (BLE) module, a Wi-Fi communication module, a cellular communication module, a third generation (3G) mobile communication module, a fourth generation (4G) mobile communication module, a fourth-generation LTE (Long Term Evolution) communication module, or a fifth generation (5G) mobile communication module.

In one or more embodiments, the communication interface 170 may perform communication with an account management server 10, a user terminal 20, and another electronic apparatus 30.

The input/output interface 180 is configured to input and output at least one of audio and video signals. For example, the input/output interface 180 may be a High Definition Multimedia Interface (HDMI), but this is provided as an example, and the input/output interface 180 may be another interface, such as Mobile High-Definition Link (MHL), Universal Serial Bus (USB), Display Port (DP), Thunderbolt, Video Graphics Array (VGA) port, RGB port, D-subminiature (D-SUB), and Digital Visual Interface (DVI). Depending on the implementation, the input/output interface 180 may include separate ports for input/output of only audio signals and only video signals, or may be implemented as a single port that inputs and outputs both audio and video signals. In particular, the electronic apparatus 100 may obtain at least one input image through the input/output interface 180.

The processor 190 may control the electronic apparatus 100 according to at least one instruction stored in the memory 160.

In particular, the processor 190 may include one or more processors. Specifically, the one or more processors may include one or more of a central processing unit (CPU), a graphics processing unit (GPU), an accelerated processing unit (APU), a many integrated core (MIC), a Digital Signal Processor (DSP), a neural processing unit (NPU), a hardware accelerator, or a machine learning accelerator. The one or more processors may control one or any combination of other components of the electronic apparatus, and may perform operations related to communication or data processing. The one or more processors may execute one or more programs or instructions stored in the memory. For example, the one or more processors may perform a method according to an embodiment by executing one or more instructions stored in the memory.

In a case where the method according to an embodiment of the disclosure includes a plurality of operations, the plurality of operations may be performed by one processor or by a plurality of processors. For example, in a case where a first operation, a second operation, and a third operation are performed by the method according to an embodiment, all of the first operation, the second operation, and the third operation may be performed by a first processor, or the first operation and the second operation may be performed by the first processor (e.g., a general-purpose processor) and the third operation may be performed by a second processor (e.g., an artificial intelligence-dedicated processor).

The one or more processors may be implemented as a single-core processor including one core, or may be implemented as one or more multi-core processors including a plurality of cores (e.g., homogeneous multiple cores or heterogeneous multiple cores). In a case where the one or more processors are implemented as multi-core processors, each of the plurality of cores included in the multi-core processors may include a processor internal memory such as a cache memory or an on-chip memory, and a common cache shared by the plurality of cores may be included in the multi-core processors. In addition, each of the plurality of cores (or some of the plurality of cores) included in the multi-core processors may independently read and execute program instructions for implementing the method according to an embodiment, or all (or some) of the plurality of cores may be linked to each other to read and execute program instructions for implementing the method according to an embodiment.

In a case where the method according to an embodiment includes a plurality of operations, the plurality of operations may be performed by one of the plurality of cores included in the multi-core processors, or may be performed by the plurality of cores. For example, in a case where a first operation, a second operation, and a third operation are performed by the method according to an embodiment, all of the first operation, the second operation, and the third operation may be performed by a first core included in the multi-core processors, or the first operation and the second operation may be performed by the first core included in the multi-core processors, and the third operation may be performed by a second core included in the multi-core processors.

The processor 190 may refer to a system on a chip (SoC) in which one or more processors and other electronic components are integrated, a single-core processor, multi-core processors, or a core included in the single-core processor or the multi-core processors and here, the core may be implemented as CPU, GPU, APU, MIC, DSP, NPU, hardware accelerator, machine learning accelerator, or the like, but embodiments are not limited thereto.

In particular, when an event corresponding to a user in a seat inside the vehicle is detected, the processor 190, by executing at least one instruction, obtains information about the user seated in the seat corresponding to the electronic apparatus 100 and destination information. Based on the information about the seat, the information about the user, and the destination information, the processor 190 obtains and provides content. When user interaction or context information for content recommendation is obtained while the vehicle is traveling, the processor 190 obtains and provides information about recommended content corresponding to the user interaction or the context information.

In one or more embodiments, when the content is navigation content, and preset user interaction for content recommendation is input at a first location on the map while the navigation content is being provided, the processor 190 may obtain information related to the first location on the map. Based on the information related to the first location, the processor 190 may obtain and provide information about recommended content related to tourist attractions or restaurants around the first location.

In one or more embodiments, when user interaction in which the user is pointing at a building outside the vehicle is detected through the sensor 140 while the vehicle is traveling, the processor 190 may obtain an image of the building through a camera installed in the vehicle. The processor 190 may recognize the building from the image and obtain information related to the building. Based on the information related to the building, the processor 190 may obtain and provide recommended content related to the building. For example, the processor 190 may recognize the building based on the image and other information, such as location information.

In one or more embodiments, the processor 190 may obtain information about the estimated travel time to the destination while the vehicle is traveling, compare the obtained travel time with the remaining playback time of the content, and if the travel time is shorter than the remaining playback time, summarize the content using a neural network model to match the travel time and generate summarized content, which can be provided as recommended content.

In one or more embodiments, the processor 190 may obtain information about the estimated travel time to the destination while the vehicle is traveling, compare the obtained travel time with the remaining playback time of the content, and if the travel time is shorter than the remaining playback time, obtain and provide information about a recommended route that corresponds to the remaining playback time.

In one or more embodiments, when there is an area along the route where communication is not available while the vehicle is traveling, the processor 190 may identify recommended content to be downloaded before entering the communication dead zone based on the size of the area, download the identified content, and once the vehicle enters the communication dead zone, provide the downloaded recommended content.

In one or more embodiments, the processor 190 may obtain information about the user's conversation while the vehicle is traveling, obtain information about a new destination based on the obtained conversation information, and obtain and provide recommended content based on the information about the new destination.

In one or more embodiments, when preset user interaction is detected during content playback, the processor 190 may obtain information about the content screen that is being played at the time when the preset user interaction is detected, obtain information about a stopover based on the content screen information, and when user interaction for adding the stopover is detected, the processor 190 may add the stopover to the travel route.

In one or more embodiments, when an event in which the user terminal 20 logged in with the same user account as the electronic apparatus 100 taps the electronic apparatus 100 is detected, the processor 190 may obtain user information and a content list from the user terminal 20.

In one or more embodiments, the processor 190 may control the communication interface 170 to transmit information related to the recommended content to the server 10 that manages the user account of the electronic apparatus 100. Here, the account management server 10 may obtain related content based on the information related to the recommended content, and provide information about the recommended content or related content to another electronic apparatus logged in with the same user account as the electronic apparatus 100.

FIG. 2 is a block diagram illustrating configuration for providing recommended content included in an electronic apparatus according to an embodiment. As shown in FIG. 2, the electronic apparatus 100 may include a context information acquisition module 210, a user pattern acquisition module 220, a content acquisition module 230, a content recommendation module 240, a content generation module 250, and a content playback module 260. The modules shown in FIG. 2 may be implemented under control of the processor 190. The components are provided as an example, and depending on the type of electronic apparatus 100, some modules (i.e., components) may be removed or added.

The context information acquisition module 210 may obtain context information of the user or inside the vehicle. Here, the context information refers to information providing data that helps understand the situation or environment inside the vehicle, and may include information about the user, location information, destination information, time information, weather information, etc.

In one or more embodiments, the context information acquisition module 210 may obtain information about the user through the account management server 10 or the user terminal 20. Here, the user information may include information related to the user, such as user identification information, user preference information, and user schedule information.

In one or more embodiments, the context information acquisition module 210 may obtain user information through the camera 120 or the sensor 140.

In one or more embodiments, the context information acquisition module 210 may obtain location information through a Global Positioning System (GPS) module which identifies distances from multiple satellites, and identifies a location based on the identified distances.

In one or more embodiments, the context information acquisition module 210 may obtain destination information through the user terminal 20 or a user input.

In one or more embodiments, the context information acquisition module 210 may obtain context information such as time or weather information through an external server.

The user pattern acquisition module 220 may obtain information about the user's content consumption pattern by identifying the user's content consumption tendencies. Here, the user may include the driver or passengers. The user pattern acquisition module 220 may also obtain information about user patterns through the words or tone used by the user.

The content acquisition module 230 may receive a content list for the user to view based on the user account. In addition, the content acquisition module 230 may download information about content preferred by the user (e.g., user preference information).

The content recommendation module 240 may obtain recommended content based on context information or user interaction. In one or more embodiments, the content recommendation module 240 may obtain information about recommended content based on information about the user or information about the seat occupied by the user.

The content generation module 250 may generate various recommended content based on context information. In one or more embodiments, the content generation module 250 may generate a summarized version of the content based on the travel route. In one or more embodiments, the content generation module 250 may generate a content playlist including a plurality of recommended content obtained based on context information.

The content playback module 260 may collect user data to play content. In this regard, the content playback module 260 may recognize a user and play content based on the recognized user. For example, when the user is the driver, the content playback module 260 may play audio-based content. When the user is a passenger, the content playback module 260 may play video-based content. Further, when the user is the driver, the content playback module 260 may play content that includes safety-related information.

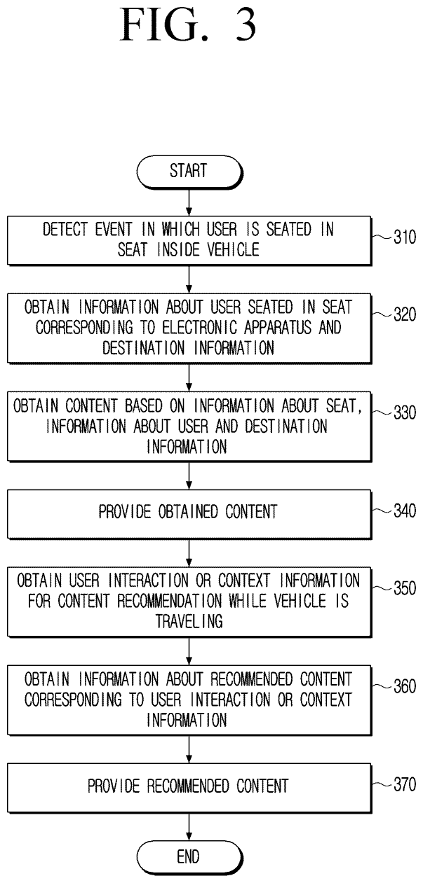

FIG. 3 is a flowchart provided to explain a method for providing recommended content included in an electronic apparatus according to an embodiment.

Each operation described below may be performed sequentially, but embodiments are not necessarily limited to sequential performance of the operations. For example, the order of the operations may be changed, and at least two operations may be performed in parallel.

According to one or more embodiments, it may be understood that operations 310 to 370 are performed by (e.g., under control of) the processor (e.g., the processor 190 in FIG. 1) of the electronic apparatus (e.g., the electronic apparatus 100 in FIG. 1).

The electronic apparatus 100 may detect an event in which the user is seated in a seat inside the vehicle (310). In one or more embodiments, the electronic apparatus 100 may detect an event in which the user is seated in a seat inside the vehicle using an image captured by the camera 120. In one or more embodiments, the electronic apparatus 100 may detect an event in which the user is seated in a seat inside the vehicle based on user interaction of tapping the user terminal 20 held by the user. In one or more embodiments, the electronic apparatus 100 may detect an event in which the user is seated in a seat inside the vehicle based on an output of a sensor associated with the seat. In one or more embodiments, when the user's seating is detected through a sensor inside the vehicle, the electronic apparatus 100 may detect the event in which the user is seated in the seat inside the vehicle based on a signal received from the vehicle.

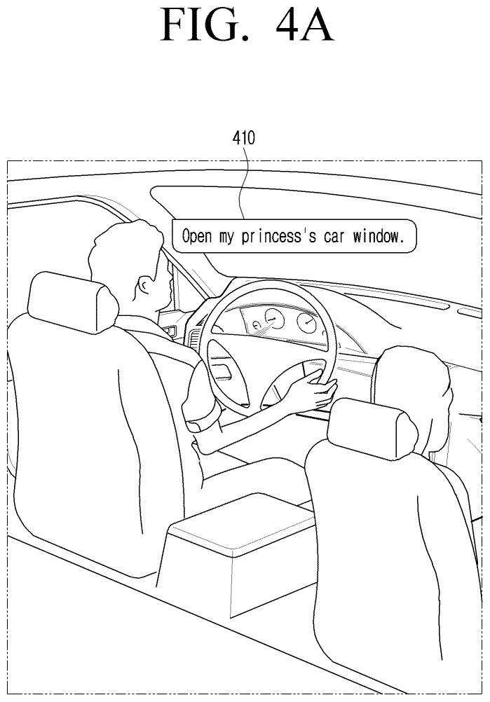

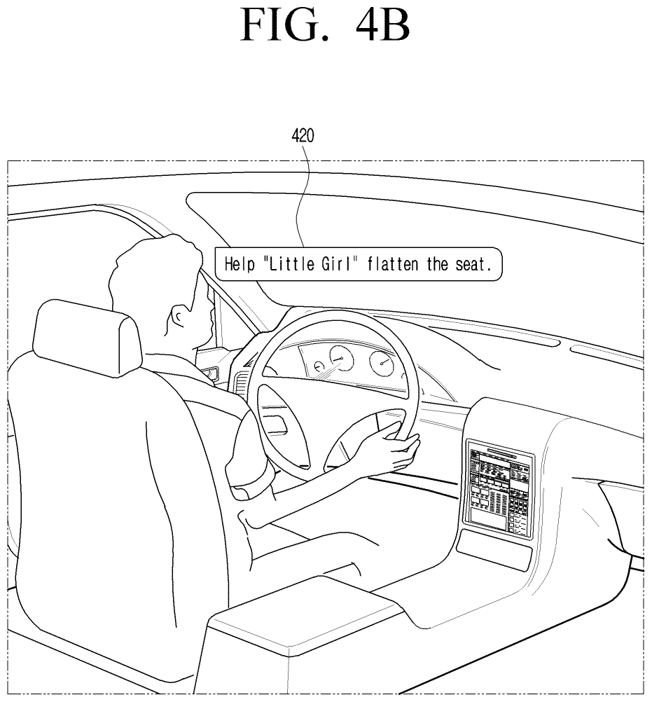

The electronic apparatus 100 may obtain information about the user seated in the seat corresponding to the electronic apparatus 100 and destination information (320). In one or more embodiments, the electronic apparatus 100 may recognize the user seated in the seat through the camera 120 or the sensor 140, and obtain information about the recognized user. In one or more embodiments, the electronic apparatus 100 may recognize the user based on information about the connected user terminal 20 (e.g., user account information), and obtain information about the recognized user. In one or more embodiments, the electronic apparatus 100 may identify an age and/or gender of a user based on an image obtained through the camera 120. In one or more embodiments, the electronic apparatus 100 may receive information about the recognized user from the vehicle. In one or more embodiments, the electronic apparatus 100 may recognize the user based on the user's conversation, and obtain information about the recognized user. In particular, the electronic apparatus 100 may learn referring expressions from conversation among passengers and recognize the corresponding passenger, even if the person is not explicitly named. For example, the electronic apparatus 100 may learn a first user utterance 410, “Open my princess's car window”, as shown in FIG. 4A, and a second user utterance 420, “Help ‘Little girl’ flatten the seat”, as shown in FIG. 4B, to obtain information about the passenger referred to as “my princess” or “Little girl.”

In one or more embodiments, the electronic apparatus 100 may obtain destination information based on a user input received through the user input unit 110. In one or more embodiments, the electronic apparatus 100 may obtain destination information from the connected user terminal 20. In one or more embodiments, the electronic apparatus 100 may obtain destination information based on conversation among passengers. In this case, the electronic apparatus 100 may learn various terms a destination and obtain information about the destination. For example, the electronic apparatus 100 may recognize the term “parents' house” from conversation among passengers and obtain information about the destination corresponding to the “parents' house.” For example, the electronic apparatus 100 may recognize the term “Umyeon-dong” from conversation among passengers and obtain information about the destination (e.g., workplace) corresponding to “Umyeon-dong.”

In one or more embodiments, when an event in which the user is seated in the seat inside the vehicle is detected, the electronic apparatus 100 may provide (e.g., using the display 150) a welcome message, and provide vehicle setting information and journey-related information. Here, the vehicle setting information may include air conditioning-related information and seat setting information inside the vehicle, and the journey-related information may include information about the user's schedule and destination.

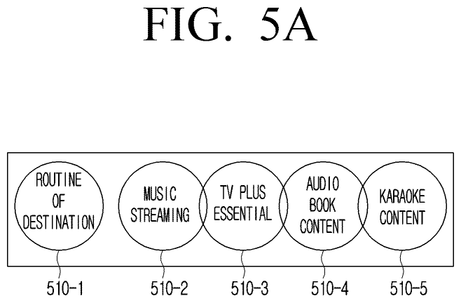

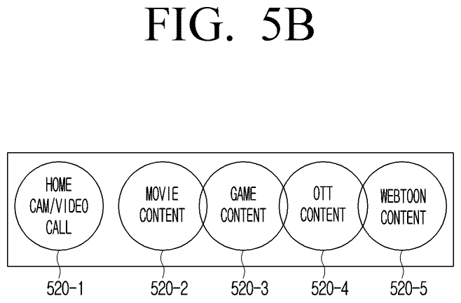

The electronic apparatus 100 may obtain content based on information about the seat, information about the user and destination information (330). In one or more embodiments, the electronic apparatus 100 may obtain at least one content item based on information about the seat corresponding to the electronic apparatus 100. In one or more embodiments, when the user is a driver, the electronic apparatus 100 may obtain at least one audio-based content item. For example, as shown in FIG. 5A, the electronic apparatus 100 may provide content 510-1 including route information to the destination, music streaming content 510-2, TV-related content 510-3, audiobook content 510-4, and karaoke content 510-5. In one or more embodiments, when the user is a passenger, the electronic apparatus 100 may provide at least one video-based content item. For example, as shown in FIG. 5B, the electronic apparatus 100 may provide home cam/video call content 520-1, movie content 520-2, game content 520-3, Over-The-Top (OTT) content 520-4, and webtoon content 520-5. Although the above example includes providing audio-based content to the driver, embodiments are not limited thereto and video-based content may also be provided to the driver based on context information. For example, when the vehicle is currently refueling or charging, the electronic apparatus 100 may provide video-based content to the driver.

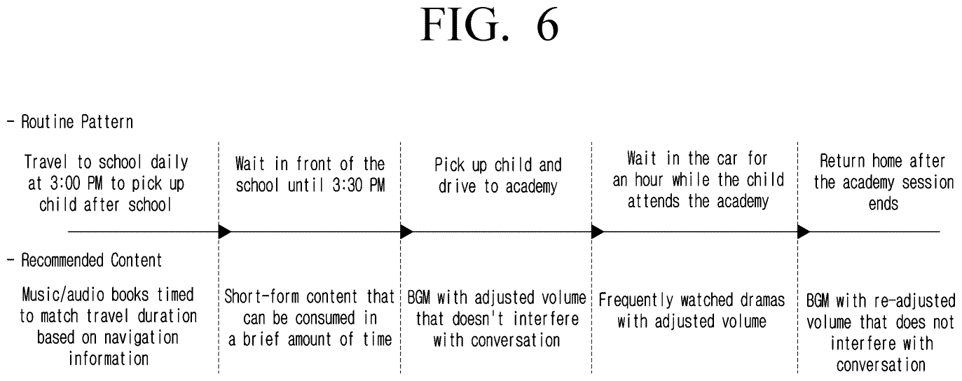

In one or more embodiments, the electronic apparatus 100 may provide at least one piece of content preferred by the user based on information about the user. In one or more embodiments, the electronic apparatus 100 may obtain pattern information about the user's daily life, and provide content based on the obtained pattern information. Here, the pattern information about daily life may include information about frequently visited destinations, travel distance, departure and arrival times, travel time to the destination, and time spent at the destination. For example, as shown in FIG. 6, when a pattern such as “traveling to school every day at 3 PM to pick up a child” is detected, the electronic apparatus 100 may provide music or audiobook content adjusted to the estimated travel time based on navigation information. When a pattern such as “waiting in front of the school until 3:30” is detected, the electronic apparatus 100 may provide short-form content that can be consumed in a short period. When a pattern such as “traveling to an academy after picking up the child” is detected, the electronic apparatus 100 may provide background music (BGM) content that does not interfere with conversation, and adjust the volume to a low level. When a pattern such as “waiting in the car for an hour until the academy ends” is detected, the electronic apparatus 100 may provide frequently watched drama content, and increase the volume. When a pattern such as “returning home after the academy” is detected, the electronic apparatus 100 may again provide BGM content that does not interfere with conversation, and adjust the volume back to a low level. In this regard, the electronic apparatus 100 may automatically provide optimal content and content playback settings by reflecting the user's daily life pattern.

In one or more embodiments, the electronic apparatus 100 may provide content based on destination information. For example, the electronic apparatus 100 may provide navigation content that provides information about a route to the destination and surrounding information. Alternatively, the electronic apparatus 100 may provide information related to the destination.

The electronic apparatus 100 may provide the obtained content (340). In one or more embodiments, when the user is a driver, the electronic apparatus 100 may provide audio-focused content, and display the navigation screen on the display 150. In one or more embodiments, when the user is a passenger, the electronic apparatus 100 may provide video-focused content. In this case, the electronic apparatus 100 may adjust the audio settings (e.g., volume, beamforming) of the video-focused content so as not to distract the driver.

The electronic apparatus 100 may obtain user interaction or context information for content recommendation while the vehicle is traveling (350). In one or more embodiments, the user interaction may be user interaction for selecting a nearby building or structure. For example, the user interaction may be a user touch of selecting a point on the navigation map, or a user gesture of pointing to a building or structure outside the vehicle. The context information may include information about changes in the current state of the vehicle or driver, information about the area where the vehicle is located, route information to the destination, and the like.

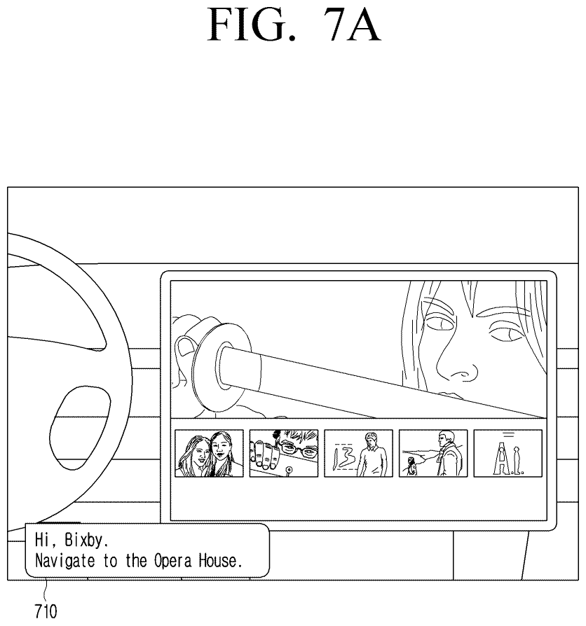

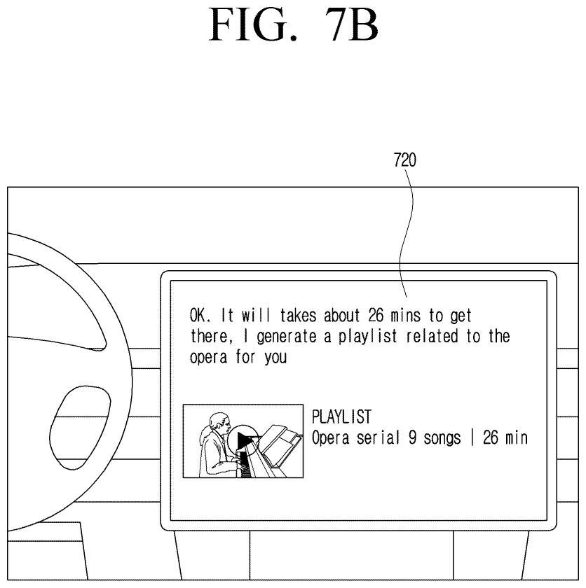

The electronic apparatus 100 may obtain information about recommended content corresponding to the user interaction or context information (360), and may provide the obtained recommended content (370). Various embodiments thereof will be described in detail with reference to FIGS. 7A to 11C.

In one or more embodiments, the electronic apparatus 100 may obtain information about recommended content based on a change in the driver's state. For example, when conversation regarding an urgent work call is obtained while the vehicle is traveling, the electronic apparatus 100 may identify context information about the obtained conversation. The electronic apparatus 100 may provide a guidance message recommending the nearest available parking location based on the obtained context information. When the electronic apparatus 100 identifies the vehicle is parked at the corresponding location, the electronic apparatus 100 may transmit setting information for utilizing the inside of the vehicle as a workspace to the vehicle. The electronic apparatus 100 may also provide information about how much the arrival time to the next destination will be delayed based on the working time. Further, the electronic apparatus 100 may provide audio content or podcast information depending on the amount of the driver's physical activity level, the weather, and the current time. For example, when the passenger boards (e.g., enters) the vehicle after exercising during the day, the electronic apparatus 100 may recommend fast-tempo music. The electronic apparatus 100 may also detect drowsy driving of the driver and provide recommended content or adjust the in-vehicle air conditioning settings (e.g., air conditioner, heater, etc.). For example, when information indicating that the driver has not had sufficient sleep is obtained from the user terminal 20, the electronic apparatus 100 may recommend music to prevent drowsy driving before the vehicle departs. In addition, the electronic apparatus 100 may recognize the user's face through the camera 120 to identify whether the driver is drowsy, and when there is a high possibility of drowsy driving, the electronic apparatus 100 may adjust the air conditioning settings or provide music or content to wake the driver up.

In one or more embodiments, the electronic apparatus 100 may recommend content according to the state of the passenger. For example, when a passenger gets in the vehicle, the electronic apparatus 100 may recognize information related to the passenger and provide recommended content corresponding to the identified passenger. When the passenger is a child, the apparatus may recommend kids'content. In addition, when the user terminal 20 is detected through the account management server 10, the electronic apparatus 100 may provide game content using the user terminal 20 as a gamepad (or controller).

In one or more embodiments, the electronic apparatus 100 may provide content based on destination information. In particular, the electronic apparatus 100 may obtain recommended content suitable for the destination, travel time to the destination, weather at the destination, and local time at the destination.

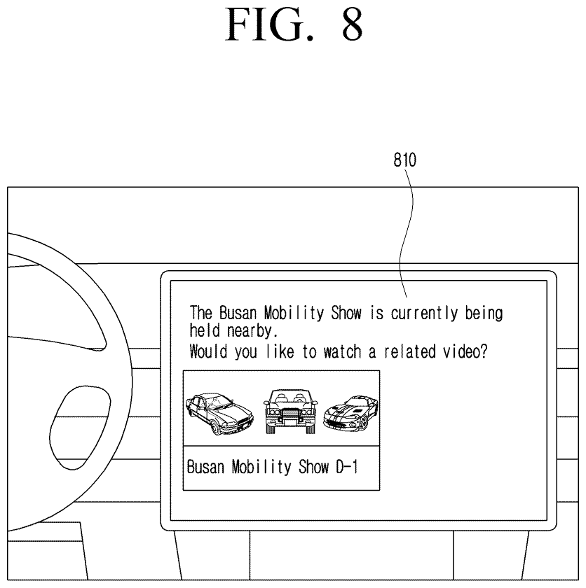

For example, as shown in FIG. 7A, the electronic apparatus 100 may obtain a user voice command (“Hi, Bixby. Navigate to the Opera House”) 710 including information about a destination through the microphone 130, as illustrated in FIG. 7A. The electronic apparatus 100 may obtain information about the destination through the obtained user voice command 710. Subsequently, as shown in FIG. 7B, the electronic apparatus 100 may provide a guidance message 720 including information about the time required to reach the destination and recommended content related to the destination based on the obtained destination information. Here, the electronic apparatus 100 may input the destination information into a trained neural network model to obtain recommended content related to the destination. In this case, the recommended content may include video content containing information about restaurants or tourist attractions near the destination, OTT content related to the destination, and music content related to the destination. For example, when the destination is Busan, the electronic apparatus 100 may provide a video related to the mobility show as recommended content along with a guidance message 810 saying, “The Busan Mobility Show is being held nearby. Would you like to play a related video?” as illustrated in FIG. 8.

In one or more embodiments, the electronic apparatus 100 may obtain recommended content based on the destination, current location, and user interaction.

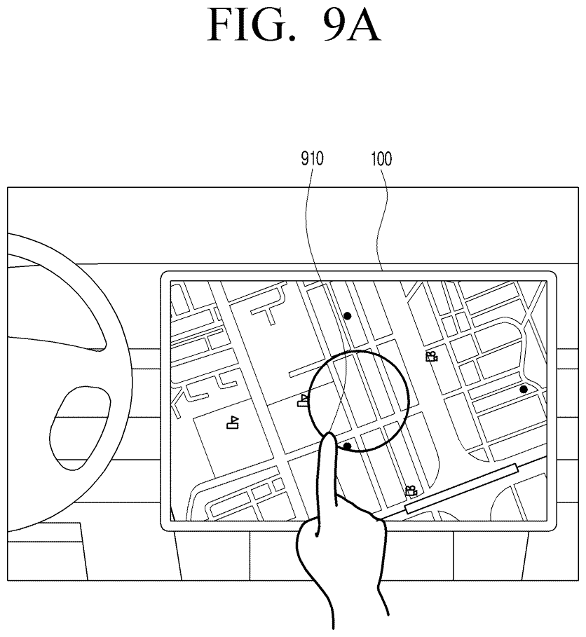

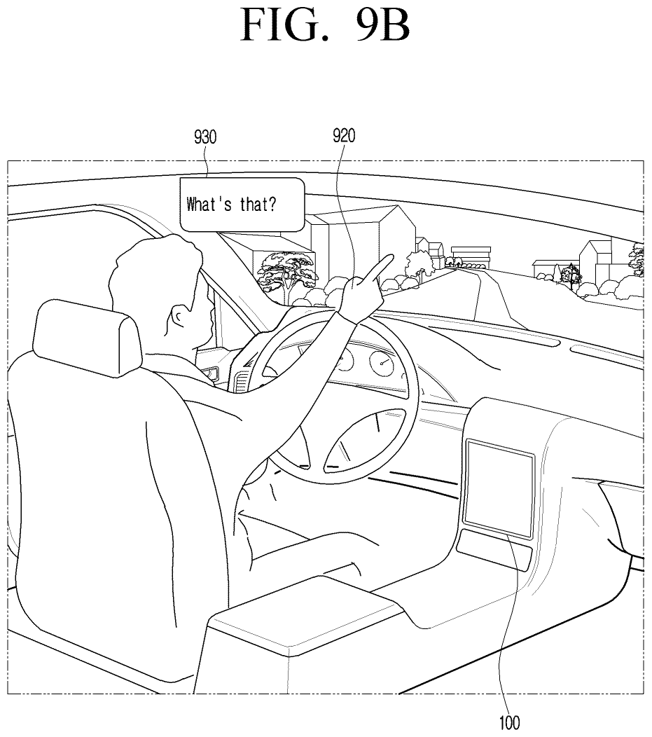

Specifically, when preset user interaction for content recommendation is input on a first location of the map while navigation content is being provided, the electronic apparatus 100 may obtain information related to the first location on the map. For example, as illustrated in FIG. 9A, when a user touch 910 drawing a circle on the first location of the map is detected, the electronic apparatus 100 may obtain information related to the first location where the user interaction 910 is detected. The information related to the first location may include information about the longitude and latitude of the first location or information about buildings or structures present at the first location. The electronic apparatus 100 may obtain and provide information about recommended content related to tourist attractions or restaurants near the first location based on the information related to the first location. In this regard, the electronic apparatus 100 may provide recommended content related to tourist attractions or restaurants located in a building situated at the longitude and latitude of the first location, or recommended content related to tourist attractions or restaurants located within a preset range of the first location.

In one or more embodiments, when user interaction of pointing to a building outside the vehicle is detected through the camera 120 or the sensor 140 while the vehicle is traveling, the electronic apparatus 100 may obtain an image of the building or structure through the camera installed in the vehicle. For example, as illustrated in FIG. 9B, when user interaction 920 pointing to a location outside the vehicle is detected along with a user voice 930 saying “What is that?” while the vehicle is traveling, the electronic apparatus 100 may identify the direction corresponding to the user interaction 920 and transmit a signal requesting an image along with information about the identified direction to the vehicle. The electronic apparatus 100 may identify the direction based on a location of the camera 120 or the sensor 140 within the vehicle, an orientation of the vehicle, and pixels associated with the finger of the user. The electronic apparatus 100 may obtain an image including the building or structure captured through the camera installed in the vehicle from the vehicle. The electronic apparatus 100 may recognize the building through the obtained image, the identified direction and information related to a current location, and obtain information related to the building. For example, the electronic apparatus 100 may input the obtained image into a trained neural network model to obtain information about the building. Here, the trained neural network model may be stored in the electronic apparatus 100, but this is provided as an example, and the trained neural network model may be stored in an external server. The electronic apparatus 100 may obtain and provide recommended content related to the building based on the information related to the building. For example, the electronic apparatus 100 may provide recommended content related to tourist attractions or restaurants located inside the recognized building or within a preset range of the recognized building.

In one or more embodiments, the electronic apparatus 100 may generate new recommended content using existing content based on the current location, route, and travel plan. In this case, the electronic apparatus 100 may generate new recommended content using a generative AI model.

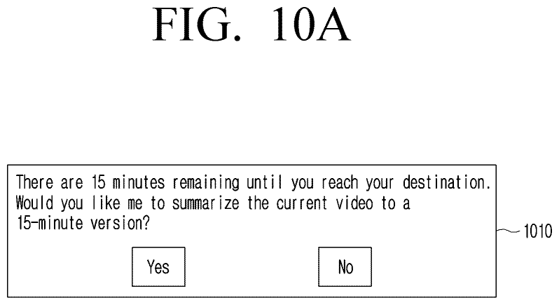

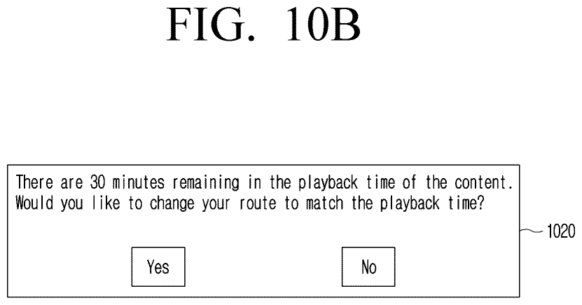

Specifically, the electronic apparatus 100 may obtain information about the travel time to the destination while the vehicle is traveling and may compare the obtained travel time with the remaining playback time of content. When the travel time is shorter than the remaining playback time, the electronic apparatus 100 may generate summarized content by summarizing the content to correspond to the travel time using a neural network model for content summarization, and may provide the summarized content as recommended content. Here, although the electronic apparatus 100 may immediately generate the summarized content, embodiments are not limited thereto. As illustrated in FIG. 10A, the electronic apparatus 100 may first display an inquiry message 1010 saying, “There are 15 minutes remaining until you reach your destination. Would you like me to summarize the current video to a 15-minute version?”, and when a user input for video summarization is received, the electronic apparatus 100 may generate the summarized content. Here, the electronic apparatus 100 may generate and provide summarized content that can be delivered as audio to the driver and as video to the passenger.

Alternatively, the electronic apparatus 100 may obtain information about the travel time to the destination while the vehicle is traveling, and compare the obtained travel time with the remaining playback time of content. When the travel time is shorter than the remaining playback time, the electronic apparatus 100 may obtain and provide information about a recommended route corresponding to the remaining playback time of the content. Here, although the electronic apparatus 100 may immediately provide the recommended route, embodiments are not limited thereto. As illustrated in FIG. 10B, the electronic apparatus 100 may first display an inquiry message 1020 saying, “There are 30 minutes remaining in the playback time of the content. Would you like to change the route to match the playback time?”, and when a user input for providing the recommended route is received, the electronic apparatus 100 may provide the recommended route.

In one or more embodiments, the electronic apparatus 100 may download content and provide it to the user based on the state of the current location where the vehicle is traveling.

Specifically, the electronic apparatus 100 may identify whether there is a communication dead zone on the route while the vehicle is traveling based on the destination information and route information. When there is a communication dead zone on the route while the vehicle is traveling, the electronic apparatus 100 may download recommended content based on the size of the communication dead zone before entering the communication dead zone. When the vehicle enters the communication dead zone, the electronic apparatus 100 may provide the downloaded recommended content.

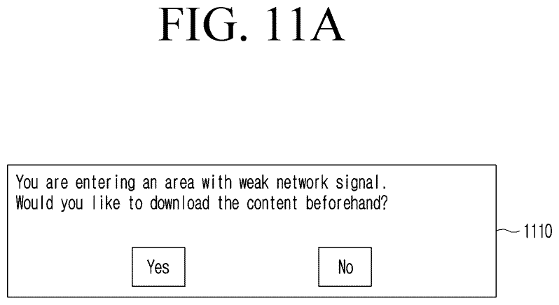

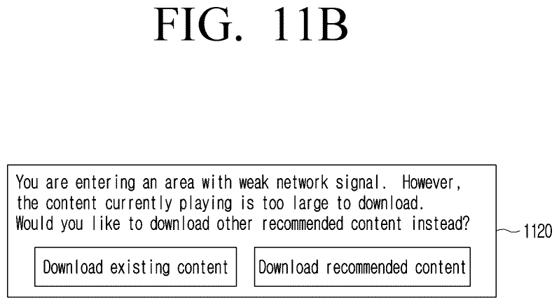

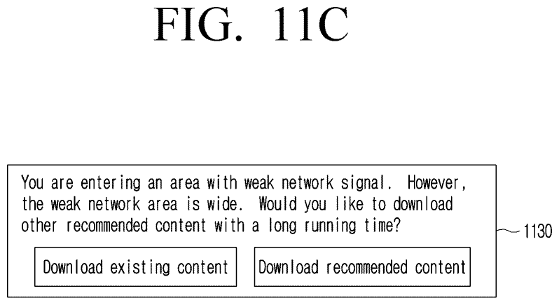

Here, before downloading the recommended content, the electronic apparatus 100 may first display a guidance message 1110 saying, “You are entering a weak network area. Would you like me to download content before entering the weak network area?” as illustrated in FIG. 11A. When a user input for downloading the recommended content is received, the electronic apparatus 100 may download the recommended content.

In particular, the electronic apparatus 100 may provide new recommended content by comparing the size of the communication dead zone with the capacity of the recommended content. Here, the size of the communication dead zone may correspond to the time during which the vehicle passes through the communication dead zone, and the capacity of the recommended content may correspond to the remaining playback time of the recommended content.

Alternatively, when a storage size of the currently provided recommended content necessary to provide the content throughout the communication dead zone results in an available storage size decreasing to less than a first threshold value, the electronic apparatus 100 may first display a guidance message 1120 saying, “You are entering an area with weak network signal. However, the content currently playing is too large to download. Would you like to download other recommended content instead?” as illustrated in FIG. 11B. When a user input for downloading other recommended content is received, the electronic apparatus 100 may obtain and provide recommended content with a size (or playback time) corresponding to the size of the communication dead zone. Here, the recommended content may have a shorter playback time (and smaller download size) than the currently provided content.

Alternatively, when the capacity of the currently provided recommended content is greater than the size of the communication dead zone by no less than a second threshold value, the electronic apparatus 100 may first display a guidance message 1130 saying, “You are entering an area with weak network signal. However, the weak network area is wide. Would you like to download other recommended content with a long running time?” as illustrated in FIG. 11C. When a user input for downloading other recommended content is received, the electronic apparatus 100 may obtain and provide recommended content with a size (or playback time) corresponding to the size of the communication dead zone. Here, the recommended content may have a longer playback time than the currently provided content.

In some embodiments, the electronic apparatus 100 may provide a variety of user experiences using the user terminal 20 or another electronic apparatus 30 that is logged in with the same user account. In particular, the electronic apparatus 100 may provide a user experience in which content provided in the home is continued to the vehicle, and content provided in the vehicle is continued to the home, which will be described in detail with reference to the drawings.

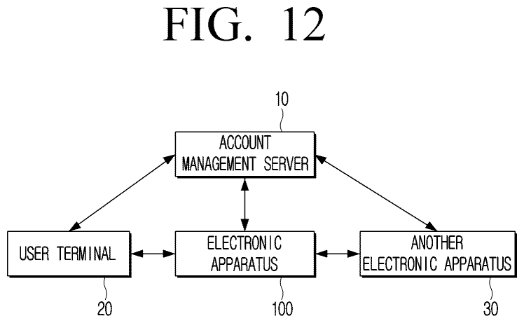

FIG. 12 is a view illustrating a system of devices that are managed under the same user account according to an embodiment. As shown in FIG. 12, the system may include the account management server 10, the user terminal 20, the electronic apparatus 100, and another electronic apparatus 30.

The account management server 10 may manage a user account, register at least one device 20, 100, 30 in connection with the user account, and perform functions such as managing or controlling the registered devices 20, 100, 30. For example, the user may access the account management server 10 through the user terminal 20 to create a user account. The user account may be identified by an ID and password set by the user. The account management server 10 may register the electronic apparatus 100 and another electronic apparatus 30 to the user account according to a predetermined procedure. For example, the account management server 10 may link identification information of the electronic apparatus 100 (e.g., serial number or MAC address) to the user account to register, manage, and control the electronic apparatus 100. The account management server 10 may store not only information about the user, but also information about content preferred by the user. In addition, the account management server 10 may store information about content playback history of the electronic apparatus 100, the user terminal 20, and another electronic apparatus 30. Although the account management server 10 may be implemented as a single server, embodiments are not limited thereto and the account management server 10 may also be implemented as a plurality of servers.

The user terminal 20 is a portable terminal carried by the user and may be implemented as a smartphone, but embodiments are not limited thereto. The user terminal 20 may register a user account with the account management server 10. In addition, the user terminal 20 may obtain information about various users and store information related to the user's schedule or recommended content. The user terminal 20 may include a communication module capable of performing communication with the electronic apparatus 100 or the account management server 10, a user interface for receiving a user input or outputting information to the user, at least one processor for controlling the operation of the user terminal 20, and at least one memory storing programs for controlling the operation of the user terminal 20.

The electronic apparatus 100 is a device installed in a vehicle, and may include an output device such as the display 150 or a speaker for providing various content. In particular, as described in FIGS. 2 to 11C, the electronic apparatus 100 may obtain and provide recommended content to the user based on user interaction or context information.

The other electronic apparatus 30 may be a device installed in the home, and may provide content to the user. For example, the other electronic apparatus 30 may be implemented as various output devices such as a TV, a projector, or a Bluetooth speaker.

In one or more embodiments, when the user boards (e.g., enters) the vehicle, the electronic apparatus 100 may receive information about the user as well as information about recommended content through the user terminal 20.

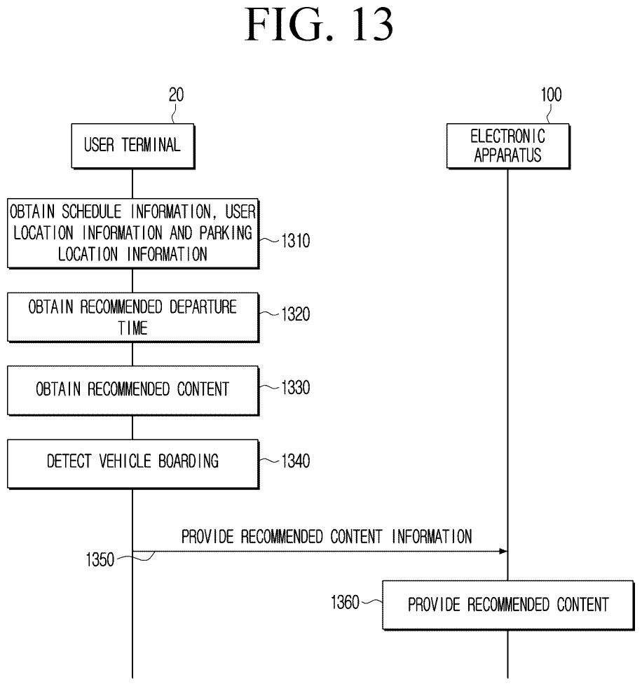

FIG. 13 is a sequence view provided to explain an example in which an electronic apparatus provides recommended content obtained through a user terminal before boarding according to an embodiment.

First, the user terminal 20 may obtain schedule information, user location information, and parking location information (1310).

The user terminal 20 may obtain a recommended departure time (1320). In this regard, the user terminal 20 may obtain the recommended departure time at which the user should depart based on the schedule registered in the user terminal 20, the user's current location, and the parking location. According to some embodiments, the user terminal 20 may also consider traffic information (including live traffic and traffic patterns) in obtaining the recommended departure time.

The user terminal 20 may obtain recommended content (1330). Specifically, the user terminal 20 may obtain at least one recommended content that can be listened to or viewed during the driving time along with the travel time to the destination. In this case, the user terminal 20 may obtain the recommended content based on information about the user (e.g., user preferences). The user terminal 20 may play the recommended content.

The user terminal 20 may detect when the user boards (e.g., enters) a vehicle (1340). In one or more embodiments, the user terminal 20 may detect vehicle boarding by sensing that the user is approaching the vehicle through a communication interface (e.g., Bluetooth interface). In one or more embodiments, when a tapping event on the electronic apparatus 100 is detected by the user terminal 20, the user terminal 20 may detect the tapping event through various sensors (e.g., vibration sensor, etc.) or communication interfaces (e.g., near-field communication (NFC) etc.) and detect that the user has boarded the vehicle.

The user terminal 20 may transmit information about recommended content to the electronic apparatus 100 (1350). Here, the user terminal 20 may transmit not only information about the recommended content but also playback information related to the recommended content played by the user terminal 20 or a content list including the recommended content. In addition, the user terminal 20 may transmit information about the user to the electronic apparatus 100.

The electronic apparatus 100 may provide recommended content based on information about the recommended content received from the user terminal 20 (1360). In this regard, the electronic apparatus 100 may provide the user with recommended content or a map currently being viewed by the user, even without a separate user input.

When the user is a passenger, the electronic apparatus 100 may be connected with the user terminal 20 of the passenger through tap interaction. The electronic apparatus 100 may receive recommended content obtained based on information about the passenger from the user terminal 20 of the passenger.

Further, when there are a plurality of passengers, at least one of a plurality of electronic apparatuses 100 may receive information about the plurality of passengers, obtain common preference information based on the information about the plurality of passengers, and obtain recommended content based on the common preference information.

When the driver boards (e.g., enters) the vehicle, the electronic apparatus 100 may provide the driver with a welcome message, vehicle setting information, and journey-related information necessary before starting driving. For example, the welcome message may be provided through the display 150 and/or a speaker of the vehicle.

Further, when the vehicle is stopped or has arrived within a threshold distance from the destination, the electronic apparatus 100 may obtain information about nearby parking lots and parking locations, and based on the obtained information about the nearby parking lots and parking locations, provide a walking route to the destination.

In one or more embodiments, after the user has exited the vehicle, the electronic apparatus 100 may provide recommended content or content related to the recommended content viewed by the user in the vehicle to another electronic apparatus 30.

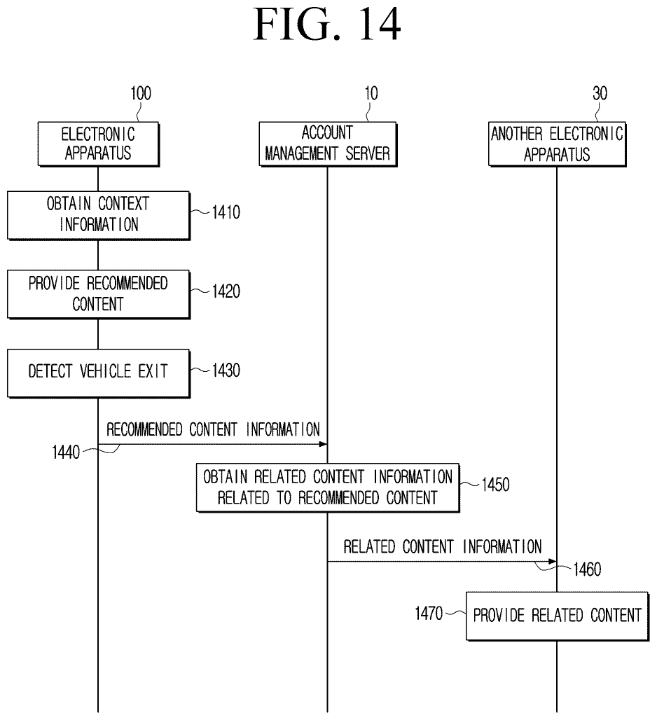

FIG. 14 is a sequence diagram provided to explain an example in which content related to recommended content is provided through another electronic apparatus after disembarking (e.g., after exiting the vehicle) according to an embodiment.

The electronic apparatus 100 may obtain context information (1410). Here, the context information may include information about the user, information about the destination, information about the environment inside the vehicle, and information about the current location of the vehicle.

The electronic apparatus 100 may provide recommended content based on the context information (1420). For example, the electronic apparatus 100 may provide music content of a singer preferred by the user while the user is in the vehicle.

The electronic apparatus 100 may detect the user's exit from the vehicle while providing the recommended content (1430). For example, the electronic apparatus 100 may detect the user's exit from the vehicle when the user turns off the vehicle ignition, opens a car door based on an output of a sensor in the vehicle, or based on an image obtained through the camera 120.

The electronic apparatus 100 may transmit information about the recommended content to the account management server 10 (1440). Here, the electronic apparatus 100 may transmit identification information, type information, playback information, and the like of the recommended content together with user account information to the account management server 10.

The account management server 10 may obtain information about content related to the recommended content based on the information about the recommended content (1450). For example, when the recommended content is music content of singer A, the electronic apparatus 100 may obtain information about video content featuring singer A as content related to the recommended content.

The account management server 10 may transmit information about the related content to another electronic apparatus 30 (1460). Here, the account management server 10 may transmit information about the related content to another electronic apparatus 30 when the user enters the home and turns on the power of another electronic apparatus 30 or when another electronic apparatus 30 logs in using the user account of the electronic apparatus.

The other electronic apparatus 30 may provide the related content (1470). In this regard, the user may continue to view content related to the content listened to or viewed in the vehicle, now at home.

As described above, the account management server 10 may obtain information about content related to the recommended content and transmits the information to another electronic apparatus 30. Embodiments are not limited thereto, and information about the recommended content may be transmitted directly to another electronic apparatus 30.

The electronic apparatus 100 may provide or modify a travel plan based on user interaction or context information, thereby providing a new user experience.

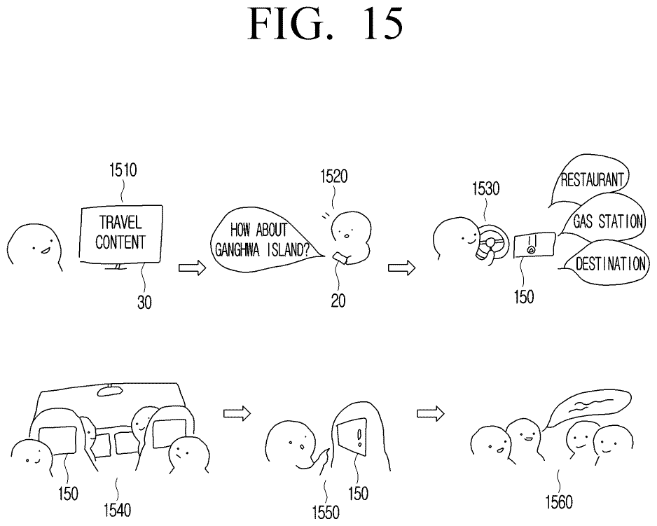

FIG. 15 is a view provided to explain an example in which a travel plan is recommended based on content being viewed according to an embodiment.

As illustrated at 1510 in FIG. 15, the user may watch video content A using another electronic apparatus 30 at home. For example, the video content A may be content related to a trip to Ganghwa Island. The other electronic apparatus 30 may transmit information about the video content A to the account management server 10.

The account management server 10 may obtain information about the travel plan based on the information indicating the video content A, and provide a guidance message suggesting the trip (e.g., “How about Ganghwa Island?”) through the user terminal 20, as illustrated at 1520 in FIG. 15.

When the user boards (e.g., enters) the vehicle to go on the trip via the guidance message, the electronic apparatus 100 may prompt the user whether to initiate the travel plan. Based on the user indicating the travel plan should be initiated, the electronic apparatus 100 may obtain information about the travel plan from the account management server 10. Here, the information about the travel plan may include locations of gas stations, restaurants or tourist spots appearing in the video content A, and route information. The electronic apparatus 100 may provide the obtained information about the travel plan to the user (e.g., through the display 150 or a speaker of the vehicle), as illustrated at 1530 in FIG. 15.

When a plurality of users board the vehicle, the electronic apparatus 100 may recognize information about the plurality of users, and provide recommended content corresponding to each of the plurality of users, as illustrated at 1540 in FIG. 15. For example, each of the plurality of users may be provided with different recommended content.

In one or more embodiments, the electronic apparatus 100 may obtain information about conversation of a plurality of users while the vehicle is traveling, and obtain information about a new destination based on the obtained conversation information. The electronic apparatus 100 may obtain and provide recommended content based on the information about the new destination. For example, when conversation such as “How about eating grilled clams before going to Ganghwa Island?” is obtained from a plurality of users, the electronic apparatus 100 may obtain information about a new destination “grilled clam restaurant A” based on the conversation and provide recommended content related to “grilled clam restaurant A.”

In one or more embodiments, when a preset user interaction is detected during content playback, the electronic apparatus 100 may obtain information about the content screen that is being played at the time corresponding to detection of the user interaction, obtain information about a stopover based on the information about the content screen, and when user interaction for adding a stopover is detected, add the stopover to the traveling route. For example, while recommended content related to luge is being played, when a preset user interaction (e.g., interaction of selecting a preset UI element provided via the display 150 or interaction including a preset user utterance) is detected as illustrated at 1550 in FIG. 15, the electronic apparatus 100 may obtain information about a stopover related to luge, and when user interaction for adding a stopover is detected, add the stopover to the traveling route.

The plurality of users may continue conversation about the content viewed in the vehicle after arriving at the destination, as illustrated at 1560 in FIG. 15. As such, the electronic apparatus 100 may provide a new user experience related to travel to the plurality of users.

In one or more embodiments, the electronic apparatus 100 may provide a smart home service using navigation information.

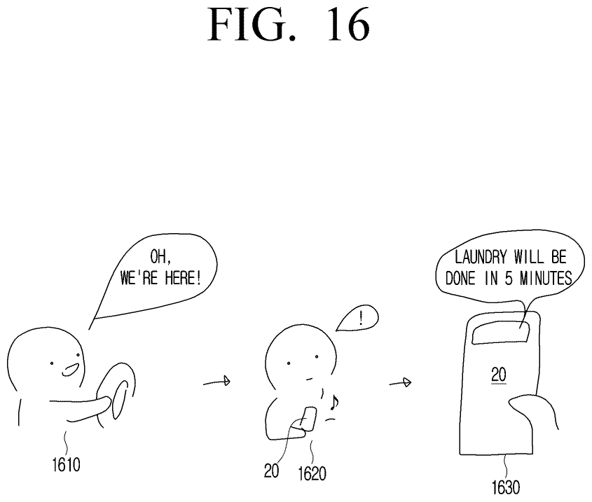

FIG. 16 is a view provided to explain an example in which a smart home service is provided in conjunction with an electronic apparatus according to an embodiment.

As illustrated at 1610 in FIG. 16, the user may recognize arrival near home.

The electronic apparatus 100 may also recognize the vehicle is approaching the home based on the location information obtained through the GPS module. When arriving near home, the electronic apparatus 100 may transmit information about the user's arrival and remaining arrival time to the account management server 10.

The account management server 10 may automatically operate home appliances (e.g., washing machines) located at home based on the information about the user's arrival and remaining arrival time. For example, the account management server 10 may turn on lights, turn on the air conditioner or induction stove, and deactivate a security system based on the information about the user's arrival. The account management server 10 may also automatically provide a status update regarding one or more home appliances in the user's home.

The account management server 10 may transmit operation information of the home appliances in the user's home to the user terminal 20. As illustrated at 1620 in FIG. 16, the user terminal 20 may provide an alarm message. Further, as illustrated at 1630 in FIG. 16, the user terminal 20 may provide the user with operation information of the home appliances, such as “Washing machine scheduled to finish in 5 minutes.”

In this regard, the account management server 10 may pre-store operation information (or routine information) of home appliances located at a preset place (e.g., home or office) through the user terminal 20. When the destination is a preset registered space, the account management server 10 may obtain arrival information from the electronic apparatus 100, and control home appliances based on the operation information of the home appliances. Further, when the vehicle ignition is turned off, the electronic apparatus 100 may provide information about preset operation information of home appliances.

In one or more embodiments, when an event of the vehicle departing from home is detected, the electronic apparatus 100 may provide departure information to the account management server 10, and the account management server 10 may control home appliances located at home based on the departure information. For example, the account management server 10 may turn off lights, turn off the air conditioner or induction stove, and activate a security system based on the departure information.

In one or more embodiments, when the vehicle is expected to arrive at the destination, the electronic apparatus 100 may perform operations such as reserving a parking space near the destination or reserving a restaurant. Alternatively, when the vehicle is expected to arrive home, the electronic apparatus 100 may place a delivery order for food preferred by the user based on user information.

In one or more embodiments, the account management server 10 may store information about the user's content viewing environment. Here, the content viewing environment may include information about lighting, brightness, volume, and the like when viewing content.

In this regard, the account management server 10 may transmit information about the content viewing environment registered for content viewing to the electronic apparatus 100, and the electronic apparatus 100 may control the environment inside the vehicle based on the obtained content viewing environment information. Alternatively, the electronic apparatus 100 may transmit information about the content viewing environment registered in the vehicle to the account management server 10, and the account management server 10 may control the viewing environment of the home or office based on the content viewing environment information registered in the vehicle. For example, the electronic apparatus 100 may set the content viewing environment information (e.g., turning off indoor lighting and setting the volume to 25) when watching a horror movie in the vehicle according to a user input. The electronic apparatus 100 may transmit the content viewing environment information to the account management server 10, and the account management server 10 may store the content viewing environment information in association with the user's account. The account management server 10 may control the environment inside the home when watching a horror movie based on the content viewing environment information. As another example, when the user always sets the air purifier to silent mode and the brightness to the highest level when watching videos in the office, the user may register this setting information as content viewing environment information through the user terminal 20, and the electronic apparatus 100 may provide the same environment in the vehicle when watching videos based on the content viewing environment information.

The methods according to an embodiment may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStoreTM) or directly between two user devices (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory of a relay server or may be temporarily generated.

The methods according to various embodiments may be implemented as software including instructions stored in machine-readable storage media, which can be read by machine (e.g.: computer). The machine may be a device that invokes the stored instruction from the storage medium and can be operated based on the invoked instruction, and may include an electronic apparatus according to embodiments disclosed herein.

The machine-readable storage media may be provided in the form of a non-transitory storage medium. Here, the ‘non-transitory storage medium’ indicates that the storage medium is tangible and does not include a signal (e.g., electromagnetic waves), and does not distinguish whether data are semi-permanently or temporarily stored in the storage medium. For example, the ‘non-transitory storage medium’ may include a buffer in which data is temporarily stored.

In case that the instruction is executed by the processor, the processor may directly perform a function corresponding to the instruction or other components may perform the function corresponding to the instruction under control of the processor. The instruction may include codes generated or executed by a compiler or an interpreter.

While aspects of embodiments have been particularly shown and described, it will be understood that various changes in form and details may be made therein without departing from the spirit and scope of the following claims.

What is claimed is:

1. An electronic apparatus provided in a vehicle, the electronic apparatus comprising:
a display;
memory storing at least one instruction; and
a processor,
wherein the at least one instruction, when executed by the processor individually or collectively, is configured to control the electronic apparatus to:
based on detecting a user is in a seat of the vehicle, obtain information about the user and destination information;
provide content obtained based on information about the seat, information about the user and the destination information; and
based on a user interaction or context information for content recommendation being obtained while the vehicle is traveling, provide information about recommended content identified based on the user interaction or the context information.

2. The electronic apparatus as claimed in claim 1, wherein based on the content being navigation content, the at least one instruction, when executed by the processor individually or collectively, is further configured to control the electronic apparatus to:
based on a preset user interaction associated with the content recommendation being input at a first location on a map while the navigation content is being provided, obtain information related to the first location on the map; and
provide information about an attraction or restaurant within a threshold distance of the first location based on the information related to the first location.

3. The electronic apparatus as claimed in claim 1, further comprising a sensor,
wherein the at least one instruction, when executed by the processor individually or collectively, is further configured to control the electronic apparatus to:
based on detection of a user interaction in which the user points to a building outside the vehicle through the sensor while the vehicle is traveling, control a camera to obtain an image of the building;
obtain information related to the building by recognizing the building through the image; and
provide the information related to the building that is obtained based on the information related to the building.

4. The electronic apparatus as claimed in claim 1, wherein the at least one instruction, when executed by the processor individually or collectively, is further configured to control the electronic apparatus to:
obtain information about an estimated time to a destination associated with the destination information while the vehicle is traveling, and compare the estimated time and remaining playback time of the content;
based on the estimated time being shorter than the remaining playback time, generate summarized content by summarizing the content to correspond to the estimated time through a neural network model for summarizing content; and
provide the summarized content as the recommended content.

5. The electronic apparatus as claimed in claim 1, wherein the at least one instruction, when executed by the processor individually or collectively, is further configured to control the electronic apparatus to:
obtain information about an estimated time to a destination associated with the destination information while the vehicle is traveling, and compare the estimated time and remaining playback time of the content; and
based on the estimated time being shorter than the remaining playback time, obtain and provide information about a recommended route corresponding to the remaining playback time of the content.

6. The electronic apparatus as claimed in claim 1, wherein the at least one instruction, when executed by the processor individually or collectively, is further configured to control the electronic apparatus to:
based on identifying a communication dead zone on a route on which the vehicle is traveling, download recommended content based on a size of the communication dead zone before entering the communication dead zone; and
provide the recommended content that has been downloaded while the vehicle is in the communication dead zone.

7. The electronic apparatus as claimed in claim 1, wherein the at least one instruction, when executed by the processor individually or collectively, is further configured to control the electronic apparatus to:
obtain conversation information about a conversation of the user while the vehicle is traveling;
obtain information about a new destination identified based on the conversation information; and
provide content identified based on the information about the new destination.

8. The electronic apparatus as claimed in claim 1, wherein the at least one instruction, when executed by the processor individually or collectively, is further configured to control the electronic apparatus to:
based on a preset user interaction being detected while the content is being played, obtain information about a content screen being played at a time associated with detection of the preset user interaction;
obtain information about a stopover based on the information about the content screen; and
based on detecting a user interaction for adding the stopover, add the stopover to a travel route.

9. The electronic apparatus as claimed in claim 1, wherein the at least one instruction, when executed by the processor individually or collectively, is further configured to control the electronic apparatus to:
based on detection of an event in which a user terminal logged in with a user account associated with the electronic apparatus tapping the electronic apparatus, obtain information about the user and a content list from the user terminal.

10. The electronic apparatus as claimed in claim 1, wherein the at least one instruction, when executed by the processor individually or collectively, is further configured to control the electronic apparatus to transmit information related to the recommended content to a server managing a user account of the electronic apparatus, and
wherein the server is configured to:
obtain related content based on the information related to the recommended content; and
provide the recommended content or information about the related content to another electronic apparatus logged in with the user account of the electronic apparatus.

11. A method of controlling an electronic apparatus provided in a vehicle, the method comprising:
based on detecting a user is in a seat of the vehicle, obtaining information about the user and destination information;
providing content obtained based on information about the seat, information about the user and the destination information; and
based on a user interaction or context information for content recommendation being obtained while the vehicle is traveling, providing information about recommended content identified based on the user interaction or the context information.

12. The method as claimed in claim 11, wherein based on the content being navigation content, the providing information about the recommended content comprises:
based on a preset user interaction associated with the content recommendation being input at a first location on a map while the navigation content is being provided, obtaining information related to the first location on the map; and
providing information about an attraction or restaurant within a threshold distance of the first location based on the information related to the first location.

13. The method as claimed in claim 11, wherein the providing information about the recommended content comprises:
based on detection of a user interaction in which the user points to a building outside the vehicle through a sensor while the vehicle is traveling, controlling a camera to obtain an image of the building;
obtaining information related to the building by recognizing the building through the image; and
providing the information related to the building that is obtained based on the information related to the building.

14. The method as claimed in claim 11, wherein the providing information about the recommended content comprises:
obtaining information about an estimated time to a destination associated with the destination information while the vehicle is traveling, and comparing the estimated time and remaining playback time of the content;
based on the estimated time being shorter than the remaining playback time, generating summarized content by summarizing the content to correspond to the estimated time through a neural network model for summarizing content; and
providing the summarized content as the recommended content.

15. The method as claimed in claim 11, wherein the providing information about the recommended content comprises:
obtaining information about an estimated time to a destination associated with the destination information while the vehicle is traveling, and comparing the estimated time and remaining playback time of the content; and
based on the estimated time being shorter than the remaining playback time, obtaining and providing information about a recommended route corresponding to the remaining playback time of the content.

16. A non-transitory computer readable recording medium having embodied thereon a program, which when executed by a processor of an electronic device, causes the electronic to execute a method including:
based on detecting a user is in a seat of a vehicle, obtaining information about the user and destination information;
providing content obtained based on information about the seat, information about the user and the destination information; and
based on a user interaction or context information for content recommendation being obtained while the vehicle is traveling, providing information about recommended content identified based on the user interaction or the context information.

17. The non-transitory computer readable recording medium as claimed in claim 16, wherein based on the content being navigation content, the providing information about the recommended content comprises:
based on a preset user interaction associated with the content recommendation being input at a first location on a map while the navigation content is being provided, obtaining information related to the first location on the map; and
providing information about an attraction or restaurant within a threshold distance of the first location based on the information related to the first location.

18. The non-transitory computer readable recording medium as claimed in claim 16, wherein the providing information about the recommended content comprises:
based on detection of a user interaction in which the user points to a building outside the vehicle through a sensor while the vehicle is traveling, controlling a camera to obtain an image of the building;
obtaining information related to the building by recognizing the building through the image; and
providing the information related to the building that is obtained based on the information related to the building.

19. The non-transitory computer readable recording medium as claimed in claim 16, wherein the providing information about the recommended content comprises:
obtaining information about an estimated time to a destination associated with the destination information while the vehicle is traveling, and comparing the estimated time and remaining playback time of the content;
based on the estimated time being shorter than the remaining playback time, generating summarized content by summarizing the content to correspond to the estimated time through a neural network model for summarizing content; and
providing the summarized content as the recommended content.

20. The non-transitory computer readable recording medium as claimed in claim 16, wherein the providing information about the recommended content comprises:
obtaining information about an estimated time to a destination associated with the destination information while the vehicle is traveling, and comparing the estimated time and remaining playback time of the content; and
based on the estimated time being shorter than the remaining playback time, obtaining and providing information about a recommended route corresponding to the remaining playback time of the content.
